(19) United States
(12) Patent Application Publication
(10) Pub. No.: US 2009/0104916 A1
(43) Pub. Date: Apr. 23, 2009

(54) Method, apparatus and system for signalling of buffer status information

(75) Inventors: Claudio Rosa, Randers (DK); Benoist Sebire, Tokyo (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Siemens Networks OY

(21) Appl. No.: 12/286,128

(22) Filed: Sep. 25, 2008

Related U.S. Application Data
(60) Provisional application No. 60/995,603, filed on Sep. 26, 2007.

(51) Int. Cl. H04W 72/00; H04M 1/00

(52) U.S. Cl. 455/453; 455/550.1

(57) ABSTRACT

The present invention is directed to a method, apparatus, system and computer program product for receiving a prioritized bit rate for a radio bearer, and setting a header element based at least on a relation of a measured data rate for the radio bearer and the prioritized bit rate for the radio bearer. A medium access control header element may be set based on the relation between the measured data rate and the prioritized bit rate for the corresponding radio bearer. A network element can derive information on the buffer status of the corresponding bearer, and lower-priority prioritized bit rate bearers. The medium access control header element may be set based on the amount of buffered data for radio bearers not included in the current transport block. The network element can derive information on the buffer status of non-prioritized bit rate bearers of priority lower than the transmitted ones.

### CROSS-REFERENCE TO RELATED APPLICATIONS

This application claims benefit of U.S. Provisional Application No. 60/995,603 filed Sep. 26, 2007, which is hereby incorporated by reference in its entirety.

### FIELD OF THE INVENTION

The present invention relates to wireless communication, and more particularly to signalling of buffer status information for Universal Mobile Telecommunications System (UMTS) Terrestrial Radio Access Network (UTRAN) or long term evolutions of E-UTRAN.

### BACKGROUND OF THE INVENTION

LTE, or Long Term Evolution, is a name for research and development involving the Third Generation Partnership Project (3GPP), to identify technologies and capabilities that can improve systems such as the UMTS. The present invention involves the long term evolution (LTE) of 3GPP. Implementations of wireless communication systems, such as UMTS (Universal Mobile Telecommunication System), may include a radio access network (RAN). In UMTS, the RAN is called UTRAN (UMTS Terrestrial RAN). Of interest to the present invention is an aspect of LTE referred to as “evolved UMTS Terrestrial Radio Access Network,” or E-UTRAN. However, it is understood that the present invention is applicable to other wireless communication systems.

In general, in E-UTRAN resources are assigned more or less temporarily by the network to one or more user equipment terminals (UE) by use of allocation tables, or more generally by use of a downlink resource assignment channel. Users are generally scheduled on a shared channel every transmission time interval (TTI) by a Node B or an evolved Node B (eNode B). A current working assumption for LTE is that users are explicitly scheduled on a shared channel every transmission time interval (TTI) by an eNodeB. An eNodeB is an evolved Node B and is the UMTS LTE counterpart to the term “base station” in the Global System for Mobile Communication (GSM). In order to facilitate the scheduling on the shared channel, the eNode B transmits an allocation in a downlink control channel to the UE. The allocation information may be related to both uplink and downlink channels. The allocation information may include information about which resource blocks in the frequency domain are allocated to the scheduled user(s), which modulation and coding schemes to use, what the transport block size is, and the like.

An example of the E-UTRAN architecture is illustrated in FIG. 1. This example of E-UTRAN consists of eNodeBs, providing the E-UTRA user plane (PDCP/RLC/MAC/PHY) and control plane (RRC) protocol terminations towards the UE. The eNodeBs are interconnected with each other by means of the X2 interface. The eNodeBs are also connected by means of the S1 interface to the EPC (evolved packet core) more specifically to the MME (mobility management entity) and the S-GW (Serving Gateway). The S1 interface supports a many-to-many relation between MMEs/S-GWs and eNBs. The S1 interface supports a functional split between the MME and the S-GW. The MME/S-GW in the example of FIG. 1 is one option for the access gateway (aGW).

In the example of FIG. 1, there exists an X2 interface between the eNodeBs that need to communicate with each other. For exceptional cases (e.g. inter-PLMN handover), LTE_ACTIVE inter-eNodeB mobility is supported by means of MME/S-GW relocation via the S1 interface.

The eNodeB may host functions such as radio resource management (radio bearer control, radio admission control, connection mobility control, dynamic allocation of resources to UEs in both uplink and downlink), selection of a mobility management entity (MME) at UE attachment, routing of user plane data towards the user plane entity (S-GW), scheduling and transmission of paging messages (originated from the MME), scheduling and transmission of broadcast information (originated from the MME or O&M), and measurement and measurement reporting configuration for mobility and scheduling. The MME/S-GW may host functions such as the following: distribution of paging messages to the eNBs, security control, IP header compression and encryption of user data streams; termination of U-plane packets for paging reasons; switching of U-plane for support of UE mobility, idle state mobility control, SAE bearer control, and ciphering and integrity protection of NAS signaling.

The invention is related to LTE, although the solution of the present invention may also be applicable to present and future systems other than LTE.

In general, E-UTRAN may use orthogonal frequency division multiplexing (OFDM) as the multiplexing technique for a downlink connection between the eNode B and the UE terminal, in which different system bandwidths from 1.25 MHz to 20 MHz are applied. Using OFDM may allow for link adaptation and user multiplexing in the frequency domain. However, to utilize the potential of multiplexing in the frequency domain the Node B or eNodeB needs to have information related to the instantaneous channel quality. In order for the Node B or eNodeB to be informed of the channel quality, the user equipment terminal provides channel quality indicator (CQI) reports to the eNodeB. The user equipment terminal may periodically or in response to a particular event send CQI reports to the respective serving eNodeB, which indicate the recommended transmission format for the next transmission time interval (TTI). The report may be constructed in such a way that it indicates the expected supported transport block size under certain assumptions, which may include, the recommended number of physical resource blocks (PRB), the supported modulation and coding scheme, the recommended multiple input multiple output (MIMO) configuration, as well as a possible power offset.

In general, the interface between a user equipment (UE) and the UTRAN or E-UTRAN has been realized through a radio interface protocol established in accordance with radio access network specifications describing a physical layer (L1), a data link layer (L2) and a network layer (L3). For example, the physical layer (PHY) provides information transfer service to a higher layer and is linked via transport channels to a medium access control (MAC) layer of the second layer (L2). Data travels between the MAC layer at L2 and the physical layer at L1, via a transport channel. The transport channel is divided into a dedicated transport channel and a common transport channel depending on whether a channel is shared. Also, data transmission is performed through a physical channel between different physical layers, namely, between physical layers of a sending side (transmitter) and a receiving side (receiver).

Typically, the second layer (L2) may include the MAC layer, a radio link control (RLC) layer, and a packet data convergence protocol (PDCP) layer. The MAC layer maps various logical channels to various transport channels. The MAC layer also multiplexes logical channels by mapping several logical channels to one transport channel. The MAC layer is connected to an upper RLC layer via the logical channel. The logical channel can be divided into a control channel for transmitting control plane information, such as control signaling, and a traffic channel for transmitting user plane information, such as data information.

In E-UTRAN, each radio bearer (RB) is mapped onto one logical channel. Over the radio, a logical channel is identified through its MAC header with an LCID (logical channel identifier). In E-UTRAN, the UE has an uplink rate control function which manages the sharing of uplink resources between radio bearers. The RRC in the eNodeB controls the uplink rate control function by giving each radio bearer a priority and a prioritised bit rate (PBR). The uplink rate control function ensures that the UE serves its radio bearer(s) in the following sequence:
1. All the radio bearer(s) in decreasing priority order up to their PBR;
2. All the radio bearer(s) in decreasing priority order for the remaining resources assigned by the grant and the function ensures that the maximum bit rate (MBR) is not exceeded.
   In case the PBRs are all set to zero, the first step is skipped and the radio bearer(s) are served in strict priority order: the UE maximises the transmission of higher priority data. By limiting the total grant to the UE, the eNodeB can ensure that the aggregate maximum bit rate (AMBR) is not exceeded. If more than one radio bearer has the same priority, the UE shall serve these radio bearers equally.

An example of the uplink rate control function is shown in FIGS. 2 and 3. FIGS. 2 and 3 represent the packet queues in the UE for the uplink, and the shaded areas indicate packets from the queue matched to grants. When a UE receives a grant for the uplink from the eNodeB, the UE serves packet queues in descending order of priority with the grant. Assuming there is adequate grant, in the first pass of packet queues the UE serves each queue up to the prioritized bit rate, and then in the second pass the UE would either serve the remainder (as explained above).

FIG. 2 shows the case where there is insufficient resource to serve the sum of the prioritized bit rates of the RBs, and in this case it can be seen that first the Prioritized Bit Rate of the priority 1 and priority 2 RBs are served in their entirety, and the remainder would be served to the priority 3 RB.

FIG. 3 shows the case where there is sufficient resource to serve the sum of the Prioritized Bit Rates of the RBs, and in this case it can be seen that first the Prioritized Bit Rate of all RBs are served in their entirety, and the remainder first is allocated to all packets in the queue of the Priority 1 RB, and then partly to priority 2 RB.

In LTE, the uplink MAC scheduler resides in the eNodeB and assigns transmission resources (resource blocks) to terminals in that cell. Furthermore, the eNodeB selects the Transport Format (TF) to be used by the terminal. In order to perform these tasks the scheduler needs information about the terminals' current buffer state, i.e., if and how much data the terminal buffers in its priority queues. It may also need further information such as the available power headroom or the transmit power used to estimate the UL gain and select a suitable TF. Very precise and up-to-date scheduling information allows accurate scheduling decisions. However, providing this information from the terminal towards the eNodeB comes at a certain cost which must be compared to the gain it offers. For example, a detailed buffer status report may be quite large in number of bits and if transmitted frequently would cost considerable overhead.

In the uplink, the cell specific packet scheduler does not have immediate access to the transmission buffers of the UE. Measurement reports from the UE are therefore extremely important to enable the scheduler to operate efficiently (especially with orthogonal multiple-access scheme as SC-FDMA). Furthermore, the E-UTRAN Stage 2 specifications, for example 3^{rd} Generation Partnership Project; Technical Specification Group Radio Access Network; Evolved Universal Terrestrial Radio Access Network (E-UTRA) and Evolved Universal Terrestrial Radio Access Network (E-UTRAN); Overall description; Stage 2 (Release 8); 3GPP TS 36.300 V8.1.0 (2007-06) which is hereby incorporated by reference in its entirety, states that buffer status reports for E-UTRAN uplink should support differentiation between radio bearers with different quality of service (QoS) requirements.

The main challenge when designing methods to signal the buffer status is to find an advantageous trade-off between the signalling overhead introduced by buffer status reports and the scheduling gain they can provide. It has been proposed to use spare bits in the MAC header of a MAC SDU to signal the buffer status of the corresponding radio bearer. It is proposed to use a 1-bit MAC header element to signal the buffer status per logical channel (i.e. per radio bearer). The buffer status information is assumed to be derived based on the amount of buffered data for the corresponding radio bearer. The main drawback of this solution is that in this way the UE can only convey to the eNodeB information on the buffer status of the radio bearer(s) that are actually transmitted in the current transport block (TB).

For example, where the UE has a VoIP connection in uplink, with an uplink grant tailored for that traffic, and at some point data from a bearer of lower priority arrive in the buffer. The UE will not be able to inform the eNodeB of this occurrence by using the specified bit field in the MAC header. The UE will need to wait until the packet scheduler allocates more resources than are needed for VoIP, or alternatively send a “dedicated” buffer status report in uplink (which on the other hand is taking some extra capacity).

The present invention is directed to an alternative way to use these spare bits which allows the packet scheduler at the eNodeB to better differentiate between radio bearers.

### SUMMARY OF THE INVENTION

In accordance with a first aspect of the present invention, a method is provided that includes receiving a prioritized bit rate for a radio bearer, and setting a header element based at least on a relation of a measured data rate for the radio bearer and the prioritized bit rate for the radio bearer.

In accordance with the first aspect of the present invention, setting of the header element is further based on an amount of buffered data for at least one radio bearer not included in a transport block.

In accordance with the first aspect of the present invention, setting of the header element includes setting a first bit of the header element when the measured data rate for the radio bearer is greater than the prioritized bit rate for the radio bearer.

In accordance with the first aspect of the present invention, when the radio bearer is not last in a protocol data unit, the method further comprises setting a bit of the header element when the measured data rate for the radio bearer is greater than the prioritized bit rate for the radio bearer.

In accordance with the first aspect of the present invention, setting the header element includes setting a second bit of the header element when the amount of buffered data is greater than zero.

In accordance with the first aspect of the present invention, when the radio bearer is last in a protocol data unit, the method further comprises setting a bit of the header element when the amount of buffered data is greater than zero.

In accordance with the first aspect of the present invention, the header element is a medium access control header element.

In accordance with the first aspect of the present invention, the radio bearer is a first transmitted radio bearer within a transport block.

In accordance with the first aspect of the present invention, the radio bearer is a second transmitted radio bearer within a transport block.

In accordance with the first aspect of the present invention, the at least one radio bearer not included in a transport block is defined by a network element.

In accordance with the first aspect of the present invention, the method further includes transmitting the header element to a network element.

In accordance with the first aspect of the present invention, the header element is set by a user equipment terminal.

In accordance with the first aspect of the present invention, a protocol data unit comprises the header element.

In accordance with the first aspect of the present invention, setting the header element includes setting a first happy bit of the header element when the measured data rate for the radio bearer is less than or equal to the prioritized bit rate for the radio bearer.

In accordance with the first aspect of the present invention, setting the header element includes setting a second happy bit of the header element when the amount of buffered data is substantially zero.

In accordance with a second aspect of the present invention, a method is provided that includes receiving a header element of a radio bearer comprising at least one bit indicating a buffer status of the radio bearer, and deriving the buffer status of the radio bearer based at least from the at least one bit.

In accordance with the second aspect of the present invention, when the at least one bit of the header element is set a priority bit rate of the radio bearer is exceeded, and at least one other priority bit rate for at least one other lower priority radio bearer is fulfilled.

In accordance with the second aspect of the present invention, when the at least one bit of the header element is set a first transmitted radio bearer does not have any additional data to transmit.

In accordance with the second aspect of the present invention, the header element is received from a user equipment terminal.

In accordance with the second aspect of the present invention, the buffer status is derived in a network element.

In accordance with the second aspect of the present invention, the method further includes transmitting a prioritized bit rate for a radio bearer.

In accordance with a third aspect of the invention, a computer program product is provided that includes a computer readable storage structure embodying computer program code thereon for execution by a computer processor, wherein the computer program code comprises instructions for performing the method according to the first aspect of the invention.

In accordance with a fourth aspect of the invention, a computer program product is provided that includes a computer readable storage structure embodying computer program code thereon for execution by a computer processor, wherein the computer program code comprises instructions for performing the method according to second aspect of the invention.

In accordance with a fifth aspect of the invention, an apparatus is provided that includes a receiver for receiving a prioritized bit rate for a radio bearer, and a setting module for setting a header element based at least on a relation of a measured data rate for the radio bearer and the prioritized bit rate for the radio bearer.

In accordance with the fifth aspect of the present invention, the setting module is configured to further base setting of the header element on an amount of buffered data for at least one radio bearer not included in a transport block.

In accordance with the fifth aspect of the present invention, the setting module is configured to set a first bit of the header element when the measured data rate for the radio bearer is greater than the prioritized bit rate for the radio bearer.

In accordance with the fifth aspect of the present invention, when the radio bearer is not last in a protocol data unit, the setting module is configured to set a bit of the header element when the measured data rate for the radio bearer is greater than the prioritized bit rate for the radio bearer.

In accordance with the fifth aspect of the present invention, the setting module is configured to set a second bit of the header element when the amount of buffered data is greater than zero.

In accordance with the fifth aspect of the present invention, when the radio bearer is last in a protocol data unit, the setting module is configured to set a bit of the header element when the amount of buffered data is greater than zero.

In accordance with the fifth aspect of the present invention, the header element is a medium access control header element.

In accordance with the fifth aspect of the present invention, the radio bearer is a first transmitted radio bearer within a transport block.

In accordance with the fifth aspect of the present invention, the radio bearer is a second transmitted radio bearer within a transport block.

In accordance with the fifth aspect of the present invention, the at least one radio bearer not included in a transport block is defined by a network element.

In accordance with the fifth aspect of the present invention, the apparatus also includes a transmitter for transmitting the header element to a network element.

In accordance with the fifth aspect of the present invention, the apparatus is included in a user equipment terminal.

In accordance with the fifth aspect of the present invention, a protocol data unit includes the header element.

In accordance with the fifth aspect of the present invention, the setting module is configured to set a first happy bit of the header element when the measured data rate for the radio bearer is less than or equal to the prioritized bit rate for the radio bearer.

In accordance with the fifth aspect of the present invention, the setting module is configured to set a second happy bit of the header element when the amount of buffered data is substantially zero.

In accordance with a sixth aspect of the present invention, an apparatus is provided that includes a receiver for receiving a header element of a radio bearer comprising at least one bit indicating a buffer status of the radio bearer, and a scheduler for deriving the buffer status of the radio bearer based at least from the at least one bit.

In accordance with the sixth aspect of the present invention, that apparatus may also include a transmitter for transmitting a prioritized bit rate for a radio bearer.

In accordance with the sixth aspect of the present invention, the apparatus includes a network element, for example a NodeB or eNodeB.

In accordance with a seventh aspect of the invention, a system is provided that includes a network element and at least one user equipment terminal. The network element, i.e. NodeB or eNodeB may include a receiver for receiving a header element of a radio bearer comprising at least one bit indicating a buffer status of the radio bearer, a scheduler for deriving the buffer status of the radio bearer based at least from the at least one bit, and a transmitter for transmitting a prioritized bit rate for a radio bearer to the at least one user equipment terminal. The user equipment terminal may include a receiver for receiving the prioritized bit rate for the radio bearer, a setting module for setting a header element based at least on a relation of a measured data rate for the radio bearer and the prioritized bit rate for the radio bearer, and a transmitter for transmitting the header element to the network element.

### BRIEF DESCRIPTION OF THE DRAWINGS

The above and other objects, features and advantages of the invention will become apparent from a consideration of the subsequent detailed description presented in connection with accompanying drawings, in which:

FIG. 1 illustrates an exemplary E-UTRAN architecture.

FIG. 2 illustrates sharing of uplink grant between queues of radio bearers when the uplink grant is below the sum of the prioritised bit rates.

FIG. 3 illustrates sharing of uplink grant between queues of radio bearers when the uplink grant is above the sum of the prioritised bit rates.

FIG. 4 illustrates a medium access control protocol data unit format that may be used in accordance with the present invention.

FIG. 5 illustrates an apparatus that may be used in a user equipment terminal according to an aspect of the present invention.

FIG. 6 illustrates an apparatus that may be used in a network element according to an aspect of the present invention.

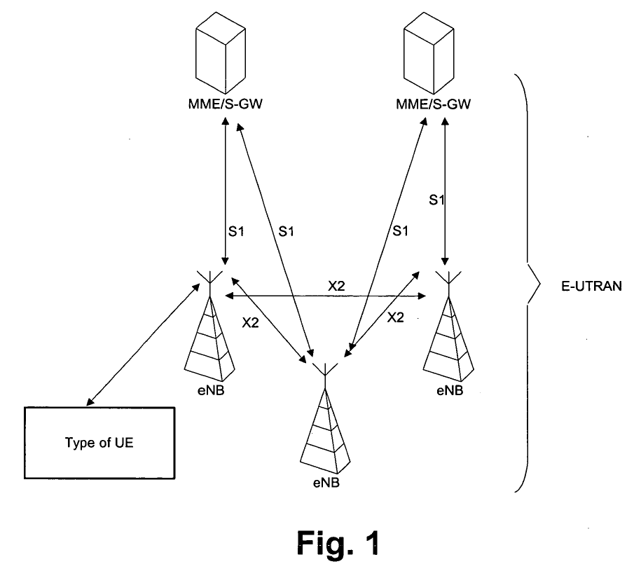

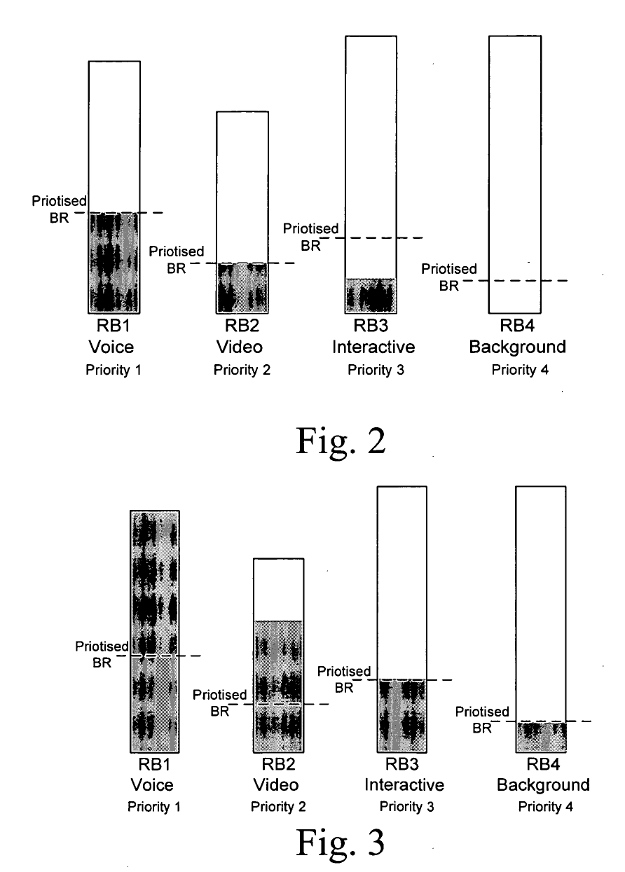

### DETAILED DESCRIPTION

An exemplary embodiment of the present invention consists of two new criteria for setting the medium access control (MAC) header element (or happy bit) used for buffer status reporting along with each transmitted radio bearer. In the first criteria the MAC header element is set based on the relation between the measured data rate and the prioritized bit rate (PBR) for the corresponding radio bearer: Due to the way data from different PBR bearers is filled into the transport block (TB), with this approach the eNodeB can derive information on the buffer status of the corresponding bearer, as well as of lower-priority PBR bearers. For example, if the MAC header element of the first transmitted bearer is set to 1 (i.e. PBR requirement is “exceeded” for that bearer), this automatically indicates that all PBR of lower priority PBR bearers are fulfilled. If the MAC header element of the second transmitted PBR bearer is set to 1 this automatically indicates that the first transmitted PBR bearer did not have any more data to transmit. In the second criteria the MAC header element is set based on the amount of buffered data for radio bearers not included in the current TB. In this way the eNodeB can derive information on the buffer status of non-PBR bearers of priority lower than the transmitted ones.

In this manner, by decoding the MAC header element the eNodeB can extract information on the buffer status of the radio bearers that are included in the current TB, but also of the bearers that are not. Alternatively for the 2^{nd} criteria, the reporting could be based on a subset of bearers, configured by the eNodeB.

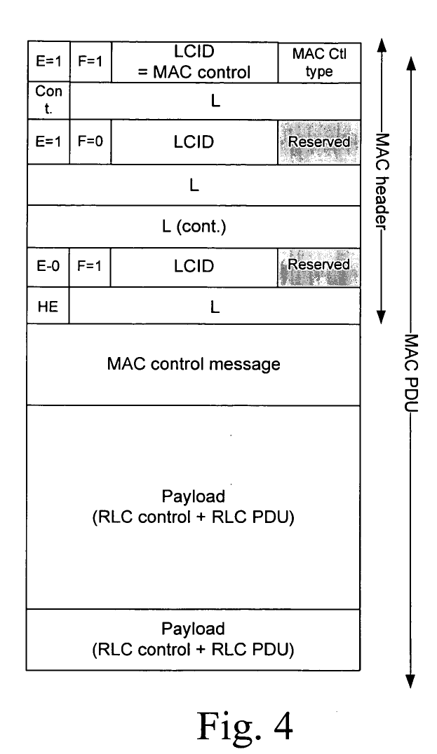

In the MAC header format shown in FIG. 4 there is a 2 bit reserved MAC header element which may be used for buffer status reporting according to the following basic rule:
First bit of MAC header element is set to 1 if Rᵢ>PBRᵢ, 0 otherwise (first criteria above)
Second bit of MAC header element is set to 1 if Bₒᵤₜ>0, 0 otherwise (second criteria above)
   Rᵢ is the measured data rate at the user equipment (UE) for radio bearer i (used anyway for prioritization between PBR radio bearers), PBRᵢ the PBR of radio bearer i, and Bₒᵤₜ is the amount of buffered data of radio bearers not included in the current TB.

In another exemplary embodiment of the invention, the method can be generalized to the case where the MAC header element for buffer reporting transmission consists of only 1 bit. In this case the rule may be:
If radio bearer is not last in MAC protocol data unit (PDU), then the MAC header bit is set is set to 1 if Rᵢ>PBRᵢ, 0 otherwise (first criteria above);
If radio bearer the last in MAC PDU (this also covers the case where the radio bearer is only one in MAC PDU), then the MAC header bit is set is set to 1 if Bₒᵤₜ>0, 0 otherwise (second criteria above).

For bearers with no PBR, the PBR may be configured to always be fulfilled. This means that when more than one non-PBR bearer is transmitted, only the last MAC header element is of interest.

In an exemplary embodiment of the invention, when all radio bearers with configured PBR are in the TB, if a bearer of higher priority carries more data then required by that radio bearer's PBR the first happy bit of its MAC header element is set. This indicates to the scheduler in the eNodeB that the last radio bearer included in the uplink (UL) TB (the one of lowest priority) has had its PRB fulfilled. This is useful for the scheduler to know whether there is enough room to guarantee the last radio bearer's PBR or not.

In another exemplary embodiment of the invention, when not all radio bearers with configured PBR are in the TB it is possible for the eNodeB to identify the radio bearers missing between the highest priority radio bearer that is sent and the last radio bearer if the eNodeB knows the assigned priorities. Those missing bearers have no data to send (otherwise the low priority bearer would not be there). If the first happy bit is set, the eNodeB can determine whether lower priority radio bearers than the lowest priority sent in the uplink TB are stuck because the UL grant is too little, or if the radio bearers do not have any data to send. As soon as one first happy bit of a transmitted PBR bearer is set to 1, it means that no PBR is left unsatisfied.

In another exemplary embodiment of the invention, when radio bearers with no PBR are not included if the second happy bit of the last radio bearer is set to 1, it indicates to the scheduler of the eNodeB that data of lower priority bearers is awaiting transmission.

In another exemplary embodiment of the invention, a radio bearer that has no more data to send can be identified by the eNodeB regardless of whether a PBR is associated to the radio bearer or not. If a PBR is associated to the bearer, the eNodeB knows that this radio bearer has no more data to send as soon as a PBR of a lower priority radio bearer is exceeded or as soon as data from a non-PBR lower priority radio bearer is sent, for example as soon as the first happy bit of a lower priority radio bearer is set to 1. When no PBR is associated to the radio bearer, the eNodeB knows that this radio bearer has no more data to send as soon as data from a lower priority radio bearer is sent, for example as soon as the first happy bit of a lower priority radio bearer is set to 1.

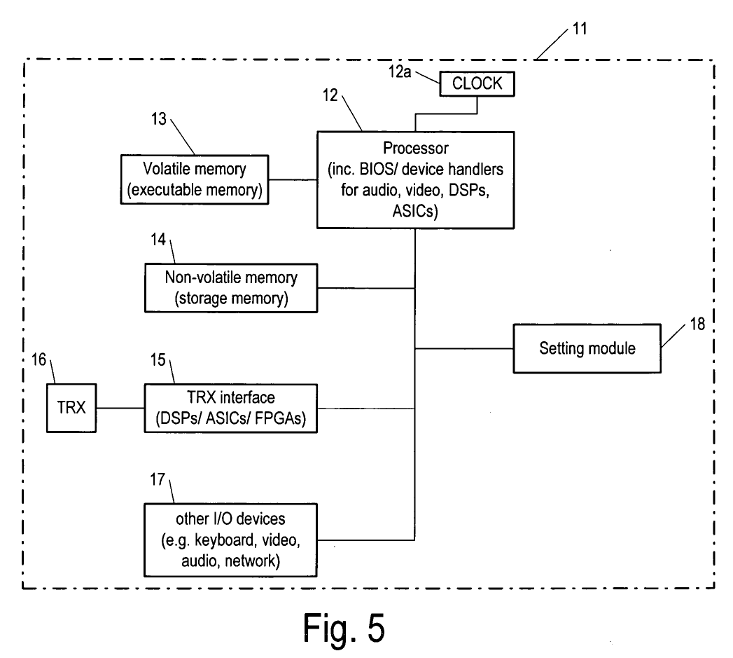

FIG. 5 shows some components of an apparatus 11 that may be included in a user equipment terminal discussed in relation to exemplary embodiments of the present invention. The apparatus may include a processor 12 for controlling operation of the device, including all input and output. The processor 12, whose speed/timing is regulated by a clock 12a, may include a BIOS (basic input/output system) or may include device handlers for controlling user audio and video input and output as well as user input from a keyboard. The BIOS/device handlers may also allow for input from and output to a network interface card. The BIOS and/or device handlers also provide for control of input and output to a transceiver (TRX) 16 via a TRX interface 15 including possibly one or more digital signal processors (DSPs), application specific integrated circuits (ASICs), and/or field programmable gate arrays (FPGAs). The TRX enables communication over the air with another similarly equipped communication terminal. The transceiver 16 may also include a receiver (not shown) for receiving a prioritized bit rate for a radio bearer from a network element, for example from an eNodeB. The transceiver 16 may also include a transmitter (not shown) for transmitting a MAC header element to a network element, such as an eNodeB. The apparatus 11 may also include volatile memory, for example so-called executable memory 13, and also non-volatile memory 14, for example storage memory. The processor 12 may copy applications (e.g. a calendar application or a game) stored in the non-volatile memory into the executable memory for execution. The processor functions according to an operating system, and to do so, the processor may load at least a portion of the operating system from the storage memory to the executable memory in order to activate a corresponding portion of the operating system. Other parts of the operating system, and in particular often at least a portion of the BIOS, may exist in the communication terminal as firmware, and are then not copied into executable memory in order to be executed. The booting up instructions are such a portion of the operating system.

Still referring to FIG. 5, the apparatus may also include a setting module 18 for setting a header element based at least on a relation of a measured data rate for a radio bearer and a prioritized bit rate for the radio bearer. The setting module 18 may be configured to further base setting of the header element on an amount of buffered data for at least one radio bearer not included in a transport block. The setting module 18 may also be configured to set a first bit of the header element when the measured data rate for the radio bearer is greater than the prioritized bit rate for the radio bearer. When the radio bearer is not last in a protocol data unit, the setting module 18 is configured to set a bit of the header element when the measured data rate for the radio bearer is greater than the prioritized bit rate for the radio bearer. The setting module 18 may be configured to set a second bit of the header element when the amount of buffered data is greater than zero. When the radio bearer is last in a protocol data unit, the setting module 18 is configured to set a bit of the header element when the amount of buffered data is greater than zero. The setting module 18 may be configured to set a first happy bit of the header element when the measured data rate for the radio bearer is less than or equal to the prioritized bit rate for the radio bearer. The setting module 18 is configured to set a second happy bit of the header element when the amount of buffered data is substantially zero.

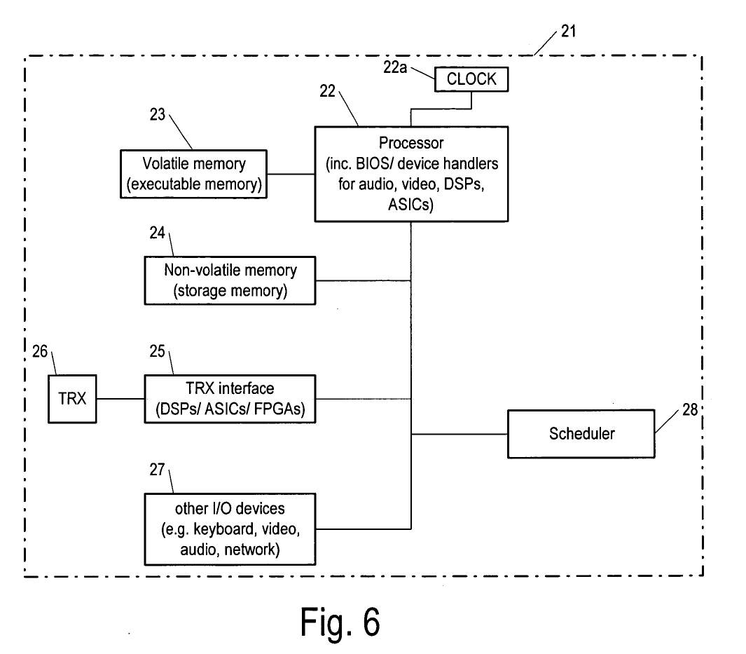

FIG. 6 shows some components of an apparatus 21 that may be included in a network element, such the eNode B discussed in relation to exemplary embodiments of the present invention. The apparatus may include a processor 22 for controlling operation of the device, including all input and output. The processor 22, whose speed/timing is regulated by a clock 22a, may include a BIOS (basic input/output system) or may include device handlers for controlling user audio and video input and output as well as user input from a keyboard. The BIOS/device handlers may also allow for input from and output to a network interface card. The BIOS and/or device handlers also provide for control of input and output to a transceiver (TRX) 26 via a TRX interface 25 including possibly one or more digital signal processors (DSPs), application specific integrated circuits (ASICs), and/or field programmable gate arrays (FPGAs). The TRX enables communication over the air with another similarly equipped communication terminal. The apparatus 21 may also include volatile memory, i.e. so-called executable memory 23, and also non-volatile memory 24, i.e. storage memory. The processor 22 may copy applications (e.g. a calendar application or a game) stored in the non-volatile memory into the executable memory for execution. The processor functions according to an operating system, and to do so, the processor may load at least a portion of the operating system from the storage memory to the executable memory in order to activate a corresponding portion of the operating system. Other parts of the operating system, and in particular often at least a portion of the BIOS, may exist in the communication terminal as firmware, and are then not copied into executable memory in order to be executed. The booting up instructions are such a portion of the operating system.

Still referring to FIG. 6, the apparatus 21 may also include a scheduler 28 for scheduling downlink packets in a sub-frame. The scheduler 28 may also be for deriving a buffer status of a radio bearer based at least from a header element of the radio bearer comprising at least one bit indicating the buffer status of the radio bearer. The transceiver 26 may include a receiver (not shown) for receiving the header element, and a transmitter (not shown) for transmitting a prioritized bit rate for a radio bearer to at least one user equipment termina.

The functionality described above (for both the radio access network and the UE) can be implemented as software modules stored in a non-volatile memory, and executed as needed by a processor, after copying all or part of the software into executable RAM (random access memory). Alternatively, the logic provided by such software can also be provided by an ASIC (application specific integrated circuit). In case of a software implementation, the invention can be provided as a computer program product including a computer readable storage structure embodying computer program code—i.e. the software—thereon for execution by a computer processor.

It is to be understood that the above-described arrangements are only illustrative of the application of the principles of the present invention. Numerous modifications and alternative arrangements may be devised by those skilled in the art without departing from the scope of the present invention.

What is claimed is:

1. A method, comprising:
receiving a prioritized bit rate for a radio bearer, and
setting a header element based at least on a relation of a measured data rate for the radio bearer and the prioritized bit rate for the radio bearer.

2. The method according to claim 1, wherein setting of the header element is further based on an amount of buffered data for at least one radio bearer not included in a transport block.

3. The method according to claim 1, wherein setting of the header element includes setting a first bit of the header element when the measured data rate for the radio bearer is greater than the prioritized bit rate for the radio bearer.

4. The method according to claim 1, wherein when the radio bearer is not last in a protocol data unit, the method further comprises setting a bit of the header element when the measured data rate for the radio bearer is greater than the prioritized bit rate for the radio bearer.

5. The method according to claim 1, wherein setting the header element comprises setting a second bit of the header element when the amount of buffered data is greater than zero.

6. The method according to claim 1, wherein when the radio bearer is last in a protocol data unit, the method further comprises setting a bit of the header element when the amount of buffered data is greater than zero.

7. The method according to claim 1, wherein the header element is a medium access control header element.

8. The method according to claim 1, wherein the radio bearer is a first transmitted radio bearer within a transport block.

9. The method according to claim 1, wherein the radio bearer is a second transmitted radio bearer within a transport block.

10. The method according to claim 1, wherein the at least one radio bearer not included in a transport block is defined by a network element.

11. The method according to claim 1, further comprising transmitting the header element to a network element.

12. The method according to claim 1, wherein the header element is set by a user equipment terminal.

13. The method according to claim 1, wherein a protocol data unit comprises the header element.

14. The method according to claim 1, wherein setting the header element includes setting a first happy bit of the header element when the measured data rate for the radio bearer is less than or equal to the prioritized bit rate for the radio bearer.

15. The method according to claim 1, wherein setting the header element includes setting a second happy bit of the header element when the amount of buffered data is substantially zero.

16. A method, comprising:
receiving a header element of a radio bearer comprising at least one bit indicating a buffer status of the radio bearer, and
deriving the buffer status of the radio bearer based at least from the at least one bit.

17. The method according to claim 16, wherein when the at least one bit of the header element is set a priority bit rate of the radio bearer is exceeded, and at least one other priority bit rate for at least one other lower priority radio bearer is fulfilled.

18. The method according to claim 16, wherein when the at least one bit of the header element is set a first transmitted radio bearer does not have any additional data to transmit.

19. The method according to claim 16, wherein the header element is received from a user equipment terminal.

20. The method according to claim 16, wherein the buffer status is derived in a network element.

21. The method according to claim 16, further comprising transmitting a prioritized bit rate for a radio bearer.

22. A computer readable storage medium embedded with a computer program, comprising programming code for:
receiving a prioritized bit rate for a radio bearer, and
setting a header element based at least on a relation of a measured data rate for the radio bearer and the prioritized bit rate for the radio bearer.

23. A computer readable storage medium embedded with a computer program, comprising programming code for:
receiving a header element of a radio bearer comprising at least one bit indicating a buffer status of the radio bearer, and
deriving the buffer status of the radio bearer based at least from the at least one bit.

24. An apparatus, comprising:
a receiver configured to receive a prioritized bit rate for a radio bearer, and
a setting module configured to set a header element based at least on a relation of a measured data rate for the radio bearer and the prioritized bit rate for the radio bearer.

25. The apparatus according to claim 24, wherein the setting module is configured to further base setting of the header element on an amount of buffered data for at least one radio bearer not included in a transport block.

26. The apparatus according to claim 24, wherein the setting module is configured to set a first bit of the header element when the measured data rate for the radio bearer is greater than the prioritized bit rate for the radio bearer.

27. The apparatus according to claim 24, wherein when the radio bearer is not last in a protocol data unit, the setting module is configured to set a bit of the header element when the measured data rate for the radio bearer is greater than the prioritized bit rate for the radio bearer.

28. The apparatus according to claim 24, wherein the setting module is configured to set a second bit of the header element when the amount of buffered data is greater than zero.

29. The apparatus according to claim 24, wherein when the radio bearer is last in a protocol data unit, the setting module is configured to set a bit of the header element when the amount of buffered data is greater than zero.

30. The apparatus according to claim 24, wherein the header element is a medium access control header element.

31. The apparatus according to claim 24, wherein the radio bearer is a first transmitted radio bearer within a transport block.

32. The apparatus according to claim 24, wherein the radio bearer is a second transmitted radio bearer within a transport block.

33. The apparatus according to claim 24, wherein the at least one radio bearer not included in a transport block is defined by a network element.

34. The apparatus according to claim 24, further comprising a transmitter for transmitting the header element to a network element.

35. The apparatus according to claim 24, wherein the apparatus is included in a user equipment terminal.

36. The apparatus according to claim 24, wherein a protocol data unit includes the header element.

37. The apparatus according to claim 24, wherein the setting module is configured to set a first happy bit of the header element when the measured data rate for the radio bearer is less than or equal to the prioritized bit rate for the radio bearer.

38. The apparatus according to claim 24, wherein the setting module is configured to set a second happy bit of the header element when the amount of buffered data is substantially zero.

39. An apparatus, comprising:
a receiver configured to receive a header element of a radio bearer comprising at least one bit indicating a buffer status of the radio bearer, and
a scheduler configured to derive the buffer status of the radio bearer based at least from the at least one bit.

40. The apparatus according to claim 39, further comprising a transmitter configured to transmit a prioritized bit rate for a radio bearer.

41. The apparatus according to claim 39, further comprising a network element.

42. A system, comprising:
a network element comprising a first receiver configured to receive a header element of a radio bearer comprising at least one bit indicating a buffer status of the radio bearer, a scheduler configured to derive the buffer status of the radio bearer based at least from the at least one bit, and a first transmitter configured to transmit a prioritized bit rate for a radio bearer to the at least one user equipment terminal; and
a user equipment terminal comprising a second receiver configured to receive the prioritized bit rate for the radio bearer, a setting module configured to set a header element based at least on a relation of a measured data rate for the radio bearer and the prioritized bit rate for the radio bearer, and a second transmitter configured to transmit the header element to the network element.
